(19) United States
(12) Patent Application Publication
(10) Pub. No.: US 2007/0124971 A1
(43) Pub. Date: Jun. 7, 2007

(54) BACKLIT SIGN AND METHOD OF MARKETING MOTORCYCLE ACCESSORIES

(76) Inventor: Jo L. Shernaman, Columbia, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/563,093

(22) Filed: Nov. 24, 2006

Related U.S. Application Data
(60) Provisional application No. 60/739,516, filed on Nov. 23, 2005.

(51) Int. Cl. G09F 13/04

(52) U.S. Cl. 40/564

(57) ABSTRACT

A sign is provided for promoting the sale of motorcycle accessories. The sign includes a primary display with a picture of a motorcycle for which accessories are available and a caption box that corresponds to each accessory. The caption box includes an individual picture of the accessory and textual information about the accessory. A method of marketing accessories is provided in which a motorcycle is displayed to consumers and accessories for that motorcycle are displayed along with information about those accessories.

This application claims priority pursuant to 35 U.S.C. 119(e) to co-pending U.S. Provisional Patent Application Ser. No. 60/739,516, filed Nov. 23, 2005, the entire disclosure of which is incorporated herein by reference.

### FIELD OF THE INVENTION

The present invention relates generally to backlit signs and marketing methods. More particularly, the present invention is concerned with a backlit sign for marketing motorcycle accessories and methods of use for backlit signs in a motorcycle dealership.

### BACKGROUND OF THE INVENTION

My prior inventions, as described in U.S. patent application Ser. No. 11/219,397, U.S. Patent Application No. 60/713,845, and U.S. Patent Application No. 60/607,049, the entire disclosures of which are incorporated herein by reference, include a number of inventions that benefit the sales and marketing of motorcycles and motorcycle accessories.

It is important in the competitive world of motorcycle sales for motorcycle dealerships to sell both motorcycles and motorcycle accessories. Motorcycles and motorcycle consumers are becoming increasingly sophisticated. Manufacturers offer an increasing variety of accessories and options that are far beyond just the make, model and color of a motorcycle and can include for example different tires, windshields, covers, lights, seats, saddlebags, and instruments. As such, consumers are becoming increasingly aware that there are different options and want to know what accessories are available to them when they purchase a new motorcycle. Furthermore, accessory sales an important source of revenue for motorcycle dealerships, and the better the dealership can provide the consumer information regarding various accessory options available to the consumer, the more likely the consumer will purchase accessories from the dealership at the same time the consumer purchases the motorcycle, or sometime in the future. Therefore, it would be beneficial for a motorcycle dealership to be able to easily and concisely provide information to consumers regarding the various accessories available for a motorcycle.

Catalogs and/or websites often show the different options for a particular motorcycle that are available to consumers. Nevertheless, there are so many different accessories available to a consumer, that looking through catalogs or on the internet can be overwhelming to the consumer, leading to frustration and making the consumer less likely to purchase some accessories. Dealerships often display various accessories to consumers in a variety of different ways in an effort to promote and sell those accessories to consumer. For example, a dealership will often place various accessories on a motorcycle that is displayed in the dealerships showroom. Nevertheless, such displays do not include information about the accessories such as price, part number, colors available, etc. In addition, due to the large number and variety (i.e. different colors and models, and from a variety of different manufacturers) of accessories available, it is difficult, if not impossible, for a dealership to display all accessory options on just one motorcycle (or even on multiple motorcycles in the showroom). It would therefore be beneficial to provide a display that incorporates the accessories on a motorcycle and provides information about the individual accessories for the consumer to make a quick and informative decision about which accessories to purchase.

### SUMMARY OF THE INVENTION

An object of the present invention is to provide a sign to display motorcycle accessories. Another object of the invention is to provide a backlit sign to display motorcycle accessories. Yet another object of the instant invention is to provide a method for selling motorcycle accessories. Still another object of the instant invention is to provide a method for selling motorcycle accessories utilizing a sign display such as a backlit sign. Another object of the instant invention is to provide an efficient, concise and informative way to display and sell motorcycle accessories.

The objects of the instant invention are accomplished through the use of a backlit sign that displays a photograph of a motorcycle with the different accessories that are offered for sale at a dealership, and separate photographs of accessories that are available for the motorcycle and which are offered for sale by the dealership. In a preferred embodiment of the instant invention, the different accessories are displayed in caption boxes that have an arrow pointing to the location on the picture of the motorcycle in which that accessory would be located. In one embodiment, the accessory will be shown on the picture of the motorcycle such that the arrow points to the actual accessory on the motorcycle. In an alternative embodiment, the arrow will simply point to the location on the motorcycle without the accessory being depicted on the motorcycle. In still another embodiment, one of several alternative accessories will be depicted on the motorcycle. The caption box for an accessory includes a picture of the accessory (or accessories if various alternatives are available) and corresponding textual information about the accessory.

In a preferred embodiment, the sign is a full color transparency that is designed for use on a F-3 fixture with a light box behind the sign and features all of the accessories that are available for the particular motorcycle depicted in the photograph.

In a preferred embodiment, the accessories are depicted separately from the motorcycle (i.e. off of the motorcycle). Although the accessories are depicted separately from the motorcycle, they may also be shown on the motorcycle, if the location is visible in the photo of the motorcycle. In one embodiment, each accessory is displayed in a caption box with an arrow pointing to the location on the motorcycle in which the accessory is traditionally located. In addition to the picture of the accessory, the caption may also include textual information regarding the accessory, such as a description, color offerings, part number, price, etc.

In another preferred embodiment, the name of the motorcycle dealership is included on the sign, as well as textual information regarding the motorcycle (i.e. brand name, model number, year, etc.).

In a preferred embodiment of the instant invention, the sign is installed in a prominent location in the motorcycle dealership showroom in the general vicinity of a fully “loaded” motorcycle (i.e. a motorcycle that includes all of the accessories shown on the sign). This allows the customers to see the accessories on an actual motorcycle and allows for easy access to information regarding those accessories.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims. The current drawings submitted are informal.

FIG. 1 is front view of a backlit sign for marketing motorcycle accessories of the present invention.

### DETAILED DESCRIPTION OF A PREFERRED EMBODIMENT

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

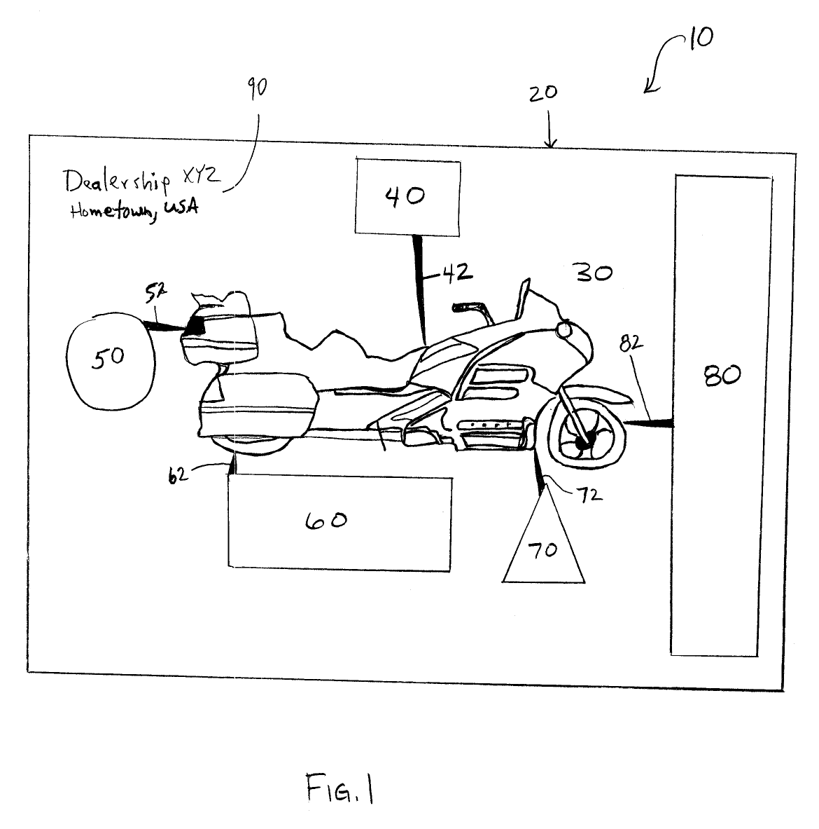

Referring to FIG. 1, a front view of a backlit sign, 10, of the instant invention is shown, including sign display 20 and a light box (not shown in FIG. 1) located behind and supporting sign display 20. In a preferred embodiment, sign display 20 is a full color transparency panel that is designed for use with a light box (such as a F-3 fixture). The light box includes a light source (such as a light bulb) and a frame for supporting the light source and sign display 20. The light source is located behind sign display 20 such that the light source of the light box illuminates sign display 20. Sign display 20 includes primary display 30 and at least secondary display (accessory caption box 40). Primary display 30 includes a picture of a motorcycle for which one or more accessories are being sold. Caption box 40 includes a picture of a motorcycle accessory (or accessories) offered for sale and/or has textual information about the accessory (or accessories) such as a description, color offerings, part number, pricing, etc. Caption box 40 includes an arrow 42 pointing to the location on the motorcycle in which the accessory (or accessories) will be located on the motorcycle. As is discussed above, the accessory may be depicted on the motorcycle shown in primary display 30, or alternatively, the accessory may be depicted only in caption box 40 with arrow 42 pointing to a location on the motorcycle without the accessory being shown on the motorcycle. Also, it will be appreciated that a single accessory may be depicted on the motorcycle in primary display 30 with various alternative accessories displayed in caption box 40. In such case the accessory displayed in primary display 30 may or may not be shown in caption box 40; however, in a preferred embodiment, at least some information regarding the accessory displayed in primary display 30 will be included in caption box 40 to provide ample information to the consumer regarding the accessory.

FIG. 1 illustrates several different types of accessories offered for the motorcycle shown in primary display 30 with corresponding caption boxes 40, 50, 60, 70, and 80 for each accessory type. Caption boxes 40, 50, 60, 70 and 80 each include an arrow (42, 52, 62, 72, and 82, respectively) pointing to the location on the motorcycle in which the accessory would be located. As is discussed above, a picture of the accessory (or accessories) for each accessory type is shown apart from the motorcycle in the caption boxes along with textual information describing the accessory further. As illustrated in FIG. 1 the size and shape of the caption boxes may vary, depending upon the location, type of accessory, number of accessories and accessory options available, amount of information displayed. It will be appreciated that any number of caption boxes may be utilized in connection with the instant invention, depending upon the number of accessories and/or types of accessories being offered. Furthermore, it will be appreciated that in embodiments in which multiple caption boxes are utilized, some caption boxes may include arrows will others may not. In addition, some arrows may point to locations on the motor cycle in primary display 30 in which accessories are displayed while other arrows may point to locations in which the accessory will be located but in which the accessory is not displayed on the motorcycle. It will be appreciated that various other combinations of features of the instant invention may be utilized in a wide variety of ways in a single display, with certain features used in connection with some (but not necessarily all) accessories displayed in sign 10, and other features used in connection with other accessories.

The dealership's name and information, 90, is also displayed on sign display 20. It will be appreciated that any information that will aid in the sale of motorcycles and motorcycle accessories may also be displayed on the backlit sign. Additionally, any accessories not able to be shown on the motorcycle, for example a cover for a motorcycle, may be displayed in a separate caption box that includes a picture and textual information regarding the accessories, but (in an preferred embodiment) without an arrow pointing to the motorcycle shown in the primary display.

It will be appreciated that the fixture that is used to hold the sign and the light box may be manufactured in a variety of ways and may have a variety of dimensions without departing from the spirit and scope of the instant invention.

Although the preferred embodiment describes primary and secondary displays 30 and 40 as including photographs of the motorcycle and accessories, it will be appreciated that any manner in which the motorcycles and accessories may be depicted (i.e. drawings, sketches, models, etc.) may be utilized without departing from the spirit and scope of the instant invention.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. A sign comprising:
a primary display including a depiction of an item for which one or more accessories is available;
a secondary display including information about said one or more accessories.

2. The sign as claimed in claim 1 wherein said sign includes a light box including a light source and a support frame, and wherein said primary and secondary displays are located on a display panel supported by said frame.

3. The sign as claimed in claim 2 wherein said display panel comprises a color transparency.

4. The sign as claimed in claim 1 wherein said item comprises a motorcycle.

5. The sign as claimed in claim 1 wherein said secondary display comprises a caption box.

6. The sign as claimed in claim 5 wherein said secondary display comprises multiple caption boxes.

7. The sign as claimed in claim 6 wherein each caption box includes information about a different type of accessory than any other caption box included in said secondary display.

8. The sign as claimed in claim 5 further comprising an arrow pointing from said caption box to a location on said item in which an accessory for which information is included in said caption box would be located on said item.

9. The sign as claimed in claim 8 wherein said accessory is shown on said item at said location.

10. The sign as claimed in 1 wherein said secondary display includes a depiction of said one or more accessories.

11. The sign as claimed in claim 10 wherein said depiction of said one or more accessories comprises a photograph of said one or more accessories.

12. The sign as claim in claim 1 wherein said depiction of said item comprises a photograph of said item.

13. The sign as claimed in claim 1 wherein said secondary display includes textual information regarding said one or more accessories.

14. The sign as claimed in claim 13 wherein the textual information includes one or more of an accessory name, part number, color, price, and description.

15. The sign as claimed in claim 1 further comprising information regarding the store in which said sign is located.

16. A method of marketing accessories comprising the steps of:
displaying an item on a sign; and
displaying information regarding accessories that may be purchased for said item on said sign.

17. The method as claimed in claim 16 wherein said item is a motorcycle and said accessories are accessories for said motorcycle.

18. The method as claimed in claim 16 further comprising the step of locating the sign in the vicinity of an actual item on which one or more accessories for which information is displayed on said sign are located.

19. The method as claimed in claim 16 wherein said information regarding accessories includes a depiction of an accessory.

20. The method as claimed in claim 16 wherein said information regarding accessories is displayed in a caption box.
